(19) United States
(12) Patent Application Publication
(10) Pub. No.: US 2006/0289253 A1
(43) Pub. Date: Dec. 28, 2006

(54) Monoblock caliper housing for a disc brake assembly

(75) Inventors: Antonio Eduardo DeMorais, South Lyon, MI (US); Harry Miller, Canton, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(73) Assignee: Kelsey-Hayes Company

(21) Appl. No.: 11/159,620

(22) Filed: Jun. 23, 2005

(51) Int. Cl. F16D 65/10

(52) U.S. Cl. 188/218 R; 188/73.1

(57) ABSTRACT

A disc brake assembly includes an anchor bracket having a leading arm with mutually aligned inboard and outboard pin holes, and a trailing arm with mutually aligned inboard and outboard pin holes. A single-part caliper housing, supported on the caliper bracket, includes a hydraulic cylinder, a piston located in the cylinder, an inboard leg, an outboard leg having an opening for providing access to the cylinder from without the caliper housing, and a bridge interconnecting the inboard leg and outboard leg. Inboard and outboard leading and trailing abutment pins are each located in one of the pin holes. Inboard and outboard brake shoes each include a backing plate having a leading aperture and a trailing aperture engaged with one of the respective abutment pins.

### BACKGROUND OF THE INVENTION

This invention relates in general to disc brake assemblies and in particular to an improved caliper for use in a disc brake assembly for a vehicle.

Most vehicles are equipped with a brake system for slowing or stopping movement of the vehicle in a controlled manner. A typical brake system for an automobile or light truck includes a disc brake assembly for each of the front wheels and either a drum brake assembly or a disc brake assembly for each of the rear wheels. The brake assemblies are actuated by hydraulic or pneumatic pressure generated when an operator of the vehicle depresses a brake pedal. The structures of these drum brake assemblies and disc brake assemblies, as well as the actuators therefor, are well known in the art.

A typical disc brake assembly includes a rotor, which is secured to the wheel of the vehicle for rotation therewith. A caliper housing is supported on pins, which are secured to an anchor bracket. The anchor bracket is secured to a non-rotatable component of the vehicle, such as the vehicle frame. The caliper assembly includes a pair of brake shoes, located on opposite sides of the rotor. The brake shoes are operatively connected to one or more hydraulically actuated pistons for movement between a non-braking position, wherein they are spaced apart from opposed axial sides or braking surfaces of the rotor, and a braking position, wherein they are moved into frictional engagement with the braking surfaces of the rotor. When the operator of the vehicle depresses the brake pedal, the piston urges the brake shoes from the non-braking position to the braking position causing their frictional engagement with the rotor's braking surfaces, thereby slowing or stopping rotation of the vehicle wheel to which the rotor is secured.

A type of disc brake assembly known in the prior art includes a sliding caliper formed in two parts for actuating the brake shoes, abutment pins for reacting loads applied to the brake shoes by the rotor, and pulled brake shoes. An example of a disc brake assembly of this type is described and illustrated in Patent Documents DE 103 12 478 A1, filed Oct. 14, 2004; and WO 2004/083668 A1, filed Mar. 12, 2004. A pulled brake shoe is one that is placed in tension by the friction force applied by the brake disc and the reaction force applied to the backing plate of the brake shoe by an abutment pin. A pushed brake shoe is one that is placed in compression by the friction force applied by the brake disc and the reaction force applied to the backing plate of the brake shoe by the abutment pin.

In the brake assembly of the type disclosed in the patent documents cited above, the inboard leg of the caliper is formed of aluminum, the bridge and outboard leg are formed of cast iron, and laterally-directed bolts pass through holes in the two parts, thereby securing the parts together. Because the inboard leg is separate from the outboard leg, the inner surface of the inboard leg is readily accessible to a machine tool that bores blind hydraulic cylinders or pots in the inboard leg of caliper housing. But forming the caliper housing in two parts of dissimilar metal requires forming several through-holes in the parts and inserting bolts in the holes to secure the parts together. These additional operations add cost and complexity to the manufacturing and assembly processes.

There is need for a one-part caliper housing in which hydraulic cylinders can be formed with a machine tool that can access the inner surface of the inboard caliper leg from outside the caliper without interfering with the abutment pins.

### SUMMARY OF THE INVENTION

A disc brake assembly according to this invention includes an anchor bracket having a leading arm with mutually aligned inboard and outboard pin holes, and a trailing arm with mutually aligned inboard and outboard pin holes. A single-part caliper housing, supported on the caliper bracket, includes a hydraulic cylinder, and piston located in the cylinder, an inboard leg, an outboard leg having an opening for providing access to the cylinder from without the caliper housing, and a bridge interconnecting the inboard leg and outboard leg. Inboard and outboard leading and trailing abutment pins are each located in one of the pin holes. Inboard and outboard brake shoes each include a backing plate having a leading aperture and a trailing aperture engaged with one of the respective abutment pins.

The one-part caliper housing permits outboard-side access for boring a blind cylinder in the cast housing by passing a cutting bore through the opening in the outboard leg. Alternatively multiple blind cylinders can be bored in this way by casting multiple openings in the outboard leg, each opening providing access for a cutting tool to one of the cylinder locations. The inboard wall of the cylinders is left intact, and avoids forming a potential a path through which hydraulic fluid could leak from the cylinder.

Forming the caliper housing in one part reduces the cost and complexity of manufacturing and assembling the housing in two parts. The one-part caliper housing requires no holes for attachment bolts, and eliminates the assembly operations needed with conventional disc brake calipers to secure the parts together. Space required for the attachment bolts is eliminated; consequently, and the housing's volume and weight are reduced in comparison to conventional brake assemblies for similar applications.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is a perspective view of a portion of a prior art vehicle disc brake assembly;

FIG. 2 is an exploded perspective view of selected components of the prior art vehicle disc brake assembly illustrated in FIG. 1;

FIG. 3 is a sectional elevation view of a portion of the prior art disc brake assembly illustrated in FIG. 1;

FIG. 4 is a perspective exploded view of a disc brake assembly according to this invention; and

FIG. 5 is an exploded perspective view of the disc brake assembly illustrated in FIG. 4.

### DETAILED DESCRIPTION OF THE PREFERRED EMBODIMENTS

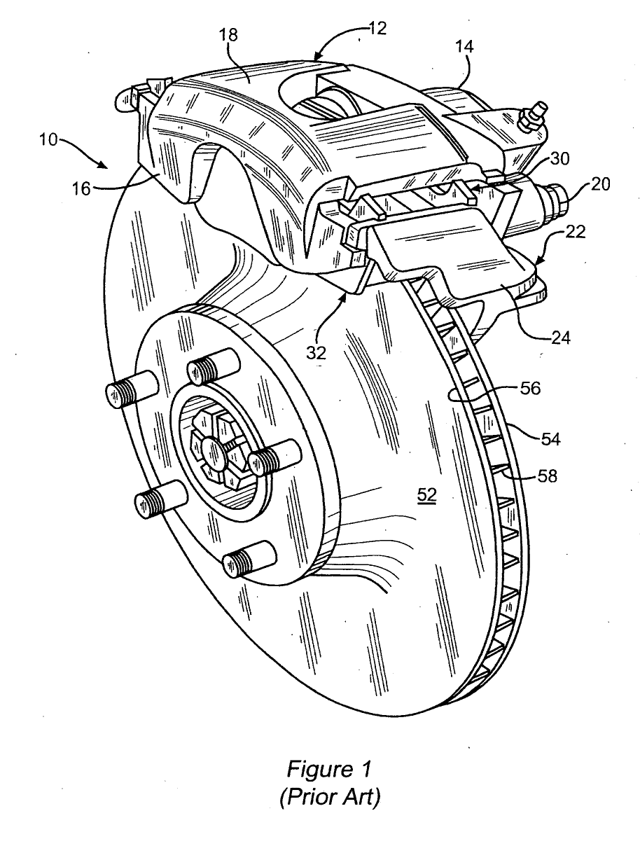

Referring now to the drawings, there is illustrated in FIGS. 1 through 3 a portion of a prior art vehicle disc brake assembly, indicated generally at 10. The general structure and operation of the prior art disc brake assembly 10 is conventional in the art. Thus, only those portions of the prior art disc brake assembly 10 that are necessary for a full understanding of this invention will be explained and illustrated. Although this invention will be described and illustrated in connection with the particular kind of vehicle disc brake assembly 10 disclosed herein, it will be appreciated that this invention may be used in connection with other kinds of disc brake assemblies if so desired.

As shown in prior art FIG. 1, the disc brake assembly 10 is a sliding type of disc brake assembly and includes a generally C-shaped caliper, indicated generally at 12. The caliper 12 includes an inboard leg portion 14 and an outboard leg portion 16, which are interconnected by an intermediate bridge portion 18. The caliper 12 is slidably supported on a pair of pins 20 secured to an anchor bracket, indicated generally at 22. The anchor bracket 22 is, in turn, secured to a stationary component of the vehicle, for example, an axle flange (not shown), when the disc brake assembly 10 is installed at a rear wheel; or a steering knuckle (not shown), when the disc brake assembly 10 is installed at a front wheel.

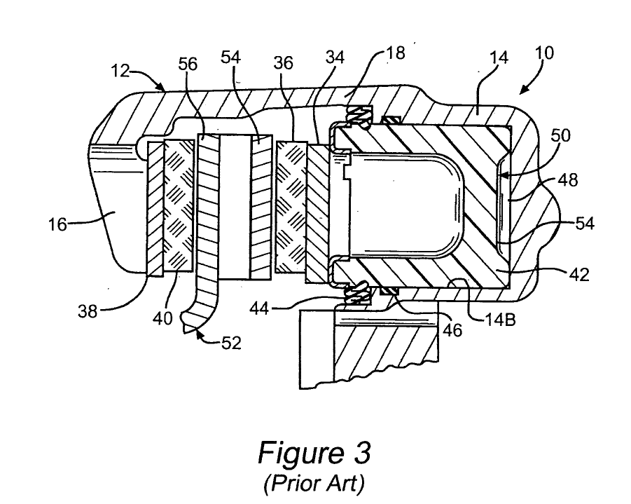

The pins 20 extend through non-threaded apertures 14A formed in the inboard leg 14 of the caliper 12. Each pin 20 has a threaded end 20A, which is received in a threaded aperture 22A provided in anchor bracket 22. The pins 20 support the caliper 12 for sliding movement relative to the anchor bracket 22 in both the outboard direction (leftward when viewing FIG. 3) and the inboard direction (rightward when viewing FIG. 3). Such sliding movement of the caliper 12 occurs when the disc brake assembly 10 is actuated, as will be explained below. A pair of bolts (not shown) extends through a pair of non-threaded apertures 22B formed in the anchor bracket 22 to secure the anchor bracket 22 to the stationary vehicle component. Alternatively, other known securing methods can be used to secure the anchor bracket 22 to the stationary vehicle component.

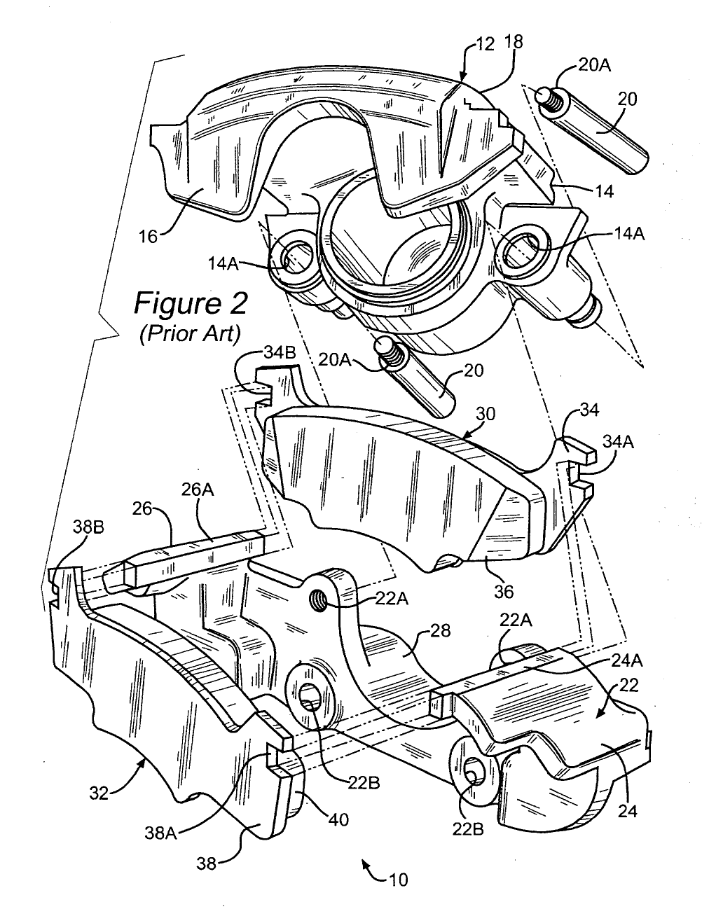

As best shown in FIG. 2, the anchor bracket 22 includes a pair of axially and outwardly extending arms 24 and 26, which are interconnected at their inboard ends by an inner tie bar 28. The arms 24 and 26 have upstanding guide rails 24A and 26A respectively formed thereon. The guide rails 24A and 26A extend transverse to the arms 24 and 26, respectively, and parallel to one another. The guide rails 24A and 26A support an inboard brake shoe 30 and an outboard brake shoe 32, respectively, which slide on the guide rails.

The inboard brake shoe 30 includes a backing plate 34 and a friction pad 36. The inboard backing plate 34 includes opposed ends having notches 34A and 34B formed therein, which engage the guide rails 24A and 26A of the anchor bracket 22 and support the inboard brake shoe 30 thereon. The outboard brake shoe 32 includes a backing plate 38 and a friction pad 40. The outboard backing plate 38 includes opposed ends having notches 38A and 38B formed therein, which engage the guide rails 24A and 26A of the anchor bracket 22 and support the outboard brake shoe 32 thereon. Alternatively, the inboard brake shoe 30 can be supported on a brake piston of the prior art disc brake assembly 10, while the outboard brake shoe 32 can be supported on the outboard leg portion 16 of the caliper 12.

An actuation means, indicated generally at 50 in FIG. 3, is provided for effecting the operation of the disc brake assembly 10. The actuation means 50 includes a brake piston 42, which is disposed in a cylinder or recess 14B, bored in the outboard surface of the inboard leg 14 of the caliper 12. The actuation means 50, shown in this embodiment as being a hydraulic actuation means, operates to move the piston 42 within the cylinder 14B in the outboard direction (leftward when viewing FIG. 3). However, other types of actuation means 50, such as electrical, pneumatic, and mechanical types, can be used.

The prior art disc brake assembly 10 also includes a dust boot seal 44 and an annular fluid seal 46. The dust boot seal 44 is formed from a flexible material and has a first end, which engages an outboard end of the cylinder 14B. A second end of the dust boot seal 44 engages an annular groove formed in an outer side wall of the piston 42. A plurality of flexible convolutions is provided in the dust boot seal 44 between the first and second ends thereof. The dust boot seal 44 is provided to prevent water, dirt, and other contaminants from entering into the recess 14B. The fluid seal 46 is disposed in an annular groove formed in a side wall of the recess 14B and engages the radial outer surface of the piston 42. The fluid seal 46 is provided to define a sealed hydraulic actuator chamber 48, within which the piston 42 is disposed for sliding movement. Also, the fluid seal 46 is designed to function as a “roll back” seal to retract the piston 42 within the recess 14B (rightward when viewing FIG. 3) when the brake pedal is released.

The prior art disc brake assembly 10 further includes a brake rotor 52, which is secured to a wheel (not shown) of the vehicle for rotation therewith. The illustrated brake rotor 52 includes a pair of opposed friction discs 54 and 56, which are spaced apart from one another by a plurality of intermediate fins or posts 58 in a known manner. The brake rotor 52 extends radially outward between the inboard friction pad 36 and the outboard friction pad 40.

When it is desired to actuate the prior art disc brake assembly 10 to retard or stop rotation of the brake rotor 52 and the vehicle wheel secure to the rotor, the driver of the vehicle depresses the brake pedal (not shown). In a manner that is well known in the art, depression of the brake pedal causes pressurized hydraulic fluid to be introduced into the cylinder 48. The pressurized hydraulic fluid urges the piston 42 in the outboard direction (toward the left when viewing art FIG. 3) into engagement with the backing plate 34 of the inboard brake shoe 30. As a result, the friction pad 36 of the inboard brake shoe 30 is moved into frictional engagement with the inboard friction disc 54 of the brake rotor 52. At the same time, the caliper 12 slides on the pins 20 in the inboard direction (toward the right when viewing art FIG. 3) such that its outboard leg 16 moves the friction pad 40 of the outboard brake shoe 32 into frictional engagement with the outboard friction disc 56 of the brake rotor 52. As a result, the opposed friction discs 54 and 56 of the brake rotor 52 are frictionally engaged by the respective friction pads 36 and 40 to slow or stop rotation of the brake rotor 52 and wheel. The structure and operation of the prior art disc brake assembly 10 thus far described is conventional in the art.

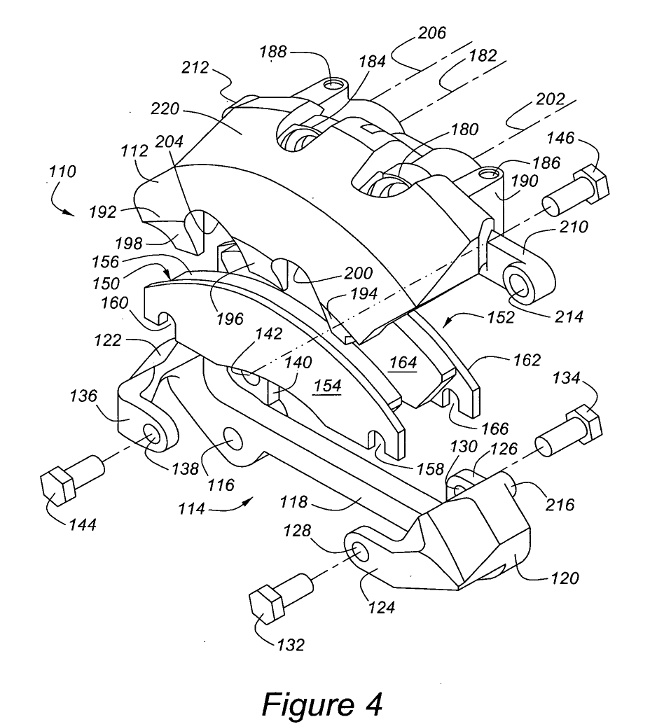

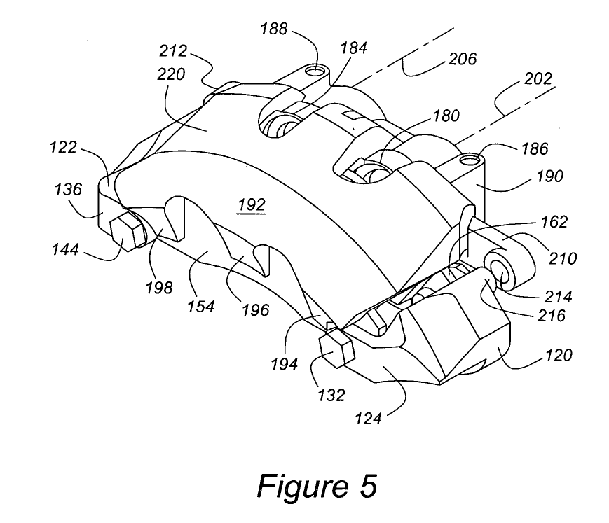

Referring now to FIGS. 4 and 5, a disc brake assembly 110 according to the present invention for slowing or stopping a brake disc 52 includes a caliper housing 112, preferably a one-part casting of ferrous metal, such as cast iron. The caliper housing 112 is used in combination with a caliper bracket 114, which is secured against displacement, preferably on a fixed steering knuckle for front wheel applications or on an axial assembly for rear wheel applications, at mounting holes 116, which are mutually spaced along an inner tie bar 118. The anchor bracket 114 is formed with a trailing arm 120, cast integrally with tie bar 118, and a leading arm 122, located at the opposite end from the leading arm 120.

Regarding the terms “leading” and “trailing” used in this description, when a brake rotor, such as the rotor 52 shown in FIG. 1, rotates clockwise while driving a vehicle wheel in the forward direction, a radius of the rotor first passes the “leading” side of the brake assembly before the rotor's radius passes the “trailing” side of the brake assembly.

An inboard lug 126 and an outboard lug 124, located on the trailing arm 120, are formed, respectively, with an outboard pin hole 128 and an inboard pin hole 130. A trailing outboard abutment pin 132 is formed with screw threads that engage screw threads tapped in pin hole 128. An inboard trailing abutment pin 134 is formed with external screw threads that engage screw threads tapped in pin hole 130. Similarly, the leading arm 122 includes an outboard lug 136, formed with an outboard leading pin hole 138, and an inboard lug 140, formed with an inboard leading pin hole 142. An outboard leading abutment pin 144 is formed with external screw threads that engage internal screw threads tapped in pin hole 138. An inboard leading abutment pin 146 is formed with external screw threads that engage internal screw threads formed in pin hole 142.

When the abutment pins 132, 134, 144 and 146 are located within their respective pin holes, the shank of each abutment pin extends through the corresponding lug and provides a surface that is engaged by apertures formed on the backing plate of the brake shoes 150, 152. Outboard brake shoe 150 includes a backing plate 154 and a lining 156 of friction material for engaging the outboard friction surface 56 of the brake disc 52. The lining 156 is secured to the backing plate 154, which is formed with a trailing aperture 158 and a leading aperture 160, which are engaged by the shank of the outboard abutment pins 132, 144, respectively. Similarly, inboard brake shoe 152 includes a backing plate 162 and a lining 164 of friction material for engaging the inboard friction surface 56 of the brake disc 52. The lining 164 is secured to the backing plate 162, which is formed with a leading aperture (not shown) and a trailing aperture 166, which are engaged by the shank of the inboard abutment pins 146, 134, respectively. Upon assembly, a brake disc and the brake shoes 150, 152 are located in the space between the outboard lugs 124, 136 and the tie bar 118.

The caliper housing 112 illustrated in FIGS. 4 and 5 is formed with two hydraulic cylinders, a leading cylinder 184, located on the leading side of the lateral axis 182, and a trailing cylinder 180, located on opposite side of the lateral axis. Each hydraulic cylinder contains a piston similar to the arrangement shown in FIG. 3. Pressurized hydraulic fluid enters the cylinders through an inlet port 188, which is hydraulically connected to a master cylinder (not shown). Hydraulic fluid exits the cylinders through a bleed port 186, fitted with a bleeder screw. The hydraulic actuation system, which includes cylinders 180, 184 and the respective pistons, is located on an inboard leg 190 of the caliper 112.

The outboard leg 192 is formed with three radial fingers, a trailing finger 194, center finger 196 and leading finger 198. Located between fingers 194, 196 is a trailing opening or throat 200, which is substantially aligned with the longitudinal axis 202 of cylinder 180. Similarly, located between fingers 196, 198 is a leading opening or throat 204, which is substantially aligned with the longitudinal axis 206 of cylinder 184.

Preferably caliper housing 112 is cast without the cylinders being formed. Access to the location of the hydraulic cylinders 180, 184 in the outboard leg 190 is available through the throats 200, 204. In this way, a machine tool can pass through the throats 200, 204 and into the outboard surfaces of the outer leg 190 while forming the cylinders in the wall of the outboard leg. The inboard end of each cylinder 180, 184 is closed by the surface on the inboard leg 190.

Extending from the body of caliper housing 112 are a trailing guide pin lug 210 and a leading guide pin lug 212. Each of these lugs 210, 212 is formed with a guide pin hole 214, which is aligned with a guide pin bore formed on a lug 216 of the trailing arm 120 and a lug of the leading arm 122, respectively, of the anchor bracket 114. On assembly of the disc brake 110, a guide pin, similar to pin 20 shown in FIG. 2, is threaded into engagement with screw threads formed in each guide pin bore and passes through a guide pin hole 214. The guide pins 20 support the caliper 112 for lateral translational displacement relative to the anchor bracket 118 as the brake is disengaged. As the brake is applied, the shoes 150, 152 are clamped by the housing 112. The frictional forces on the interface between the caliper housing and shoes will keep the housing from moving in any direction.

In operation when pressurized hydraulic fluid is admitted to the cylinders 180, 184, the pistons contained in those cylinders force the inboard brake shoe 152 laterally outward into frictional engagement with the inboard friction surface 54 of the brake disc 52. Pressure in the cylinders produces a force on the inboard leg, 190, which force is transmitted across a bridge 220 that connects the inboard leg 190 and the outboard leg 192. The cylinder pressure causes the caliper 112 to slide laterally inboard on the guide pins 20, thereby forcing the fingers 194, 196, 198 against backing plate 154. These actions cause the friction linings 156, 164 to engage the outboard and inboard friction surfaces, respectively, of the brake disc 52, thereby slowing or stopping the vehicle wheel, to which the disc is secured. When the brake pedal is relaxed, hydraulic fluid in the cylinders is vented by flowing into the master cylinder, brake pressure falls, and the friction linings of each brake pad disengage the disc 52 permitting the wheel to rotate freely.

In accordance with the provisions of the patent statutes, the principle and mode of operation of this invention have been described and illustrated in its preferred embodiments. However, it must be understood that this invention may be practiced otherwise than as specifically explained and illustrated without departing from its spirit or scope.

What is claimed is:

1. A disc brake assembly comprising:
an anchor bracket including a leading arm having mutually aligned inboard and outboard leading pin holes, and a trailing arm having mutually aligned inboard and outboard trailing pin holes;
a caliper housing formed of a unitary part, supported on the caliper bracket for lateral displacement thereon, including a hydraulic cylinder, an inboard leg, an outboard leg having an opening extending through a thickness of the outboard leg for providing access to the cylinder from without the caliper, and a bridge interconnecting the inboard leg and outboard leg;
a piston located in the cylinder for translational displacement therein axis;
an inboard leading abutment pin and an inboard trailing abutment pin, each inboard abutment pin located in a respective inboard pin hole;
an outboard leading abutment pin and an outboard trailing abutment pin, each outboard abutment pin being located in a respective outboard pin hole;
an inboard brake shoe including a backing plate having an inboard leading aperture and an inboard trailing aperture, each aperture engaged with a respective inboard abutment pin; and
an outboard brake shoe including a backing plate having an outboard leading aperture and an outboard trailing aperture, each aperture engaged with a respective outboard abutment pin.

2. The disc brake assembly of claim 1 wherein the anchor bracket has mounting holes for securing the anchor bracket against displacement.

3. The disc brake assembly of claim 1 wherein:
the caliper housing includes multiple cylinders;
the outboard leg has multiple openings, each opening extending through a thickness of the outboard leg and providing access to a cylinder from without the caliper, the openings defining fingers, each finger spaced from an adjacent finger by an opening and contacting the backing plate of the outboard brake shoe; and
further comprising multiple pistons, each piston located in a cylinder for movement therein.

4. The disc brake assembly of claim 1 wherein the caliper further includes a laterally-directed leading guide pin hole and a laterally-directed trailing guide pin hole, the assembly further comprising:
a first guide pin secured to the leading arm, extending laterally into the leading guide pin hole, for guiding movement of the caliper relative to the anchor bracket; and
a second guide pin secured to the trailing arm, extending laterally into the trailing guide pin hole, for guiding movement of the caliper relative to the anchor bracket.

5. The disc brake assembly of claim 1, further comprising:
a first brake shoe including a first backing plate having a first aperture aligned with the inboard leading pin hole, and a second aperture aligned with the inboard trailing pin hole; and
a second brake shoe including a second backing plate having a third aperture aligned with the outboard pin hole, and a fourth aperture aligned with outboard trailing pin hole.

6. The disc brake assembly of claim 1, further comprising:
a first brake shoe including a first backing plate having a first aperture aligned with the inboard leading pin hole, and a second aperture aligned with the inboard trailing pin hole, each inboard abutment pin located in a respective first or second aperture; and
a second brake shoe including a second backing plate having a third aperture aligned with the outboard pin hole, and a fourth aperture aligned with outboard trailing pin hole, each outboard abutment pin being located in a respective third or fourth aperture.

7. A disc brake assembly comprising:
an anchor bracket including a leading arm having mutually aligned inboard and outboard leading pin holes, a trailing arm having mutually aligned inboard and outboard trailing pin holes, and a tie bar interconnecting the leading arm and the trailing arm;
a caliper housing formed by casting in a unitary part of ferrous metal, supported on the caliper bracket for lateral displacement thereon, including a hydraulic cylinder, an inboard leg, an outboard leg having an opening extending through a thickness of the outboard leg for providing access to the cylinder from without the caliper, and a bridge interconnecting the inboard leg and outboard leg;
a piston located in the cylinder for translational displacement therein axis;
an inboard leading abutment pin and an inboard trailing abutment pin, each inboard abutment pin located in a respective inboard pin hole;
an outboard leading abutment pin and an outboard trailing abutment pin, each outboard abutment pin being located in a respective outboard pin hole;
an inboard brake shoe including a backing plate having an inboard leading aperture and an inboard trailing aperture, each aperture engaged with a respective inboard abutment pin; and
an outboard brake shoe including a backing plate having an outboard leading aperture and an outboard trailing aperture, each aperture engaged with a respective outboard abutment pin.

8. The disc brake assembly of claim 7 wherein the tie bar includes mounting holes for securing the anchor bracket against displacement.

9. The disc brake assembly of claim 7 wherein:
the caliper housing includes multiple cylinders;
the outboard leg has multiple openings, each opening extending through a thickness of the outboard leg and providing access to a cylinder from without the caliper, the openings defining fingers, each finger spaced from an adjacent finger by an opening and contacting the backing plate of the outboard brake shoe; and
further comprising multiple pistons, each piston located in a cylinder for movement therein.

10. The disc brake assembly of claim 7 wherein the caliper further includes a laterally-directed leading guide pin hole and a laterally-directed trailing guide pin hole, the assembly further comprising:
a first guide pin secured to the leading arm, extending laterally into the leading guide pin hole, for guiding movement of the caliper relative to the anchor bracket; and
a second guide pin secured to the trailing arm, extending laterally into the trailing guide pin hole, for guiding movement of the caliper relative to the anchor bracket.

11. The disc brake assembly of claim 7, further comprising:
a first brake shoe including a first backing plate having a first aperture aligned with the inboard leading pin hole, and a second aperture aligned with the inboard trailing pin hole; and
a second brake shoe including a second backing plate having a third aperture aligned with the outboard pin hole, and a fourth aperture aligned with outboard trailing pin hole.

12. The disc brake assembly of claim 7, further comprising:
a first brake shoe including a first backing plate having a first aperture aligned with the inboard leading pin hole, and a second aperture aligned with the inboard trailing pin hole, each inboard abutment pin located in a respective first or second aperture; and
a second brake shoe including a second backing plate having a third aperture aligned with the outboard pin hole, and a fourth aperture aligned with outboard trailing pin hole, each outboard abutment pin being located in a respective third or fourth aperture.

13. A method for forming a disc brake caliper comprising the steps of:
(a) forming a caliper that includes an inboard wall, an outboard wall spaced laterally from the inboard wall, and a bridge interconnecting the inboard wall and the outboard wall;
(b) forming a first leading pin hole spaced a first distance on a first side from a lateral axis through a thickness of one of the inboard wall and outboard wall;
(c) forming a first trailing pin hole spaced a second distance on a second side opposite the first side from the lateral axis through said one of the inboard wall and outboard wall;
(d) forming through a thickness of the other wall of said one of the inboard wall and outboard wall a second leading pin hole substantially axially aligned with the first leading pin; and
(e) forming through a thickness of the other wall of said one of the inboard wall and outboard wall a second trailing pin hole substantially axially aligned with the first trailing pin hole.

14. A method of claim 13 wherein step (a) further comprises:
casting the caliper from ferrous metal.

15. The method of claim 13 wherein:
step (a) further comprises machining the first leading pin hole;
step (b) further comprises machining the first trailing pin hole;
step (c) further comprises machining the second leading pin hole; and
step (d) further comprises machining the second trailing pin hole.

16. The method of claim 13 wherein the first distance is one of greater than the second distance, less than the second distance, and substantially equal to the second distance.

17. The method of claim 13 further comprising:
installing in the caliper leading abutment pins, one leading abutment pin located in each leading pin hole;
trailing abutment pins, one trailing abutment pin located in each trailing pin hole;
installing in the caliper a first brake shoe including a first backing plate having a first aperture for receiving therein and contacting the leading abutment pin of the inboard wall, and a second aperture into which the trailing abutment pin of the inboard wall extends, and a first friction pad secured to the first backing plate and facing an inner surface of the outboard wall; and
installing in the caliper a second brake shoe including a second backing plate having a first aperture for receiving therein and contacting the leading abutment pin of the outboard wall, and a second aperture into which the trailing abutment pin of the outboard wall extends, and a second friction pad secured to the second backing plate and facing an inner surface of the inboard wall and spaced laterally from the first friction pad.
